(19) United States
(12) Patent Application Publication
(10) Pub. No.: US 2017/0036945 A1
(43) Pub. Date: Feb. 9, 2017

(54) COMPOSITE POWDER AND PASTE OF COMPOSITE POWDER

(71) Applicant: Nippon Electric Glass Co., Ltd., Shiga (JP)

(72) Inventors: Kentaro ISHIHARA, Shiga (JP); Kumiko HIMEI, Shiga (JP)

(73) Assignee: Nippon Electric Glass Co., Ltd., Shiga (JP)

(21) Appl. No.: 15/103,909

(22) PCT Filed: Jan. 13, 2015
(86) PCT No.: PCT/JP2015/050584

§ 371 Date: Jun. 13, 2016

(30) Foreign Application Priority Data
Jan. 14, 2014 (JP) 2014-003885

(51) Int. Cl. C03C 3/089; C03C 17/04; C03C 8/16; C03C 8/04; C03C 3/093; C03C 4/02

(52) U.S. Cl. CPC C03C 3/089; C03C 3/093; C03C 4/02; C03C 8/16; C03C 8/04; C03C 17/04; C03C 2204/00; C03C 2207/00

(57) ABSTRACT

Provided is a composite powder, including 55 mass % to 95 mass % of glass powder, 5 mass % to 45 mass % of inorganic pigment powder, and 0 mass % to 20 mass % of refractory filler powder, in which the glass powder includes as a glass composition, in terms of mol %, 45% to 62% of SiO₂, 0% to 10% of B₂O₃, 0% to 9% of Al₂O₃, 12% to 32% of ZnO, 12% to 28% of Li₂O+Na₂O+K₂O, 0% to 10% of BaO, and 0% to 15% of TiO₂+ZrO₂.

### TECHNICAL FIELD

The present invention relates to a composite powder and a composite powder paste, and more particularly, to a composite powder and a composite powder paste for forming a colored layer in an interior peripheral edge portion of an automotive window glass, a train window glass, or a home window glass (hereinafter referred to as automotive window glass or the like).

### BACKGROUND ART

A colored layer is formed in an interior peripheral edge portion of an automotive window glass. The colored layer is formed in order to prevent ultraviolet deterioration of an organic adhesive for bonding the window glass (soda lime glass sheet) to an automobile body, and to conceal a stick-out portion of the organic adhesive. Further, in recent years, a colored layer in which a fine dot gradation pattern is formed has widely been used in order to enhance a design property.

The colored layer is formed by the following procedure: a composite powder is made into a paste; and the resultant composite powder paste is applied onto the soda lime glass sheet, followed by being dried and fired to be sintered on a surface of the soda lime glass sheet. The composite powder comprises at least glass powder and inorganic pigment powder, and as required, refractory filler powder. It should be noted that the inorganic pigment powder is generally black.

### CITATION LIST

Patent Literature 1: JP 11-157873 A

### SUMMARY OF INVENTION

### Technical Problem

In recent years, acid rain has presented environmental problems. When the colored layers formed in various glass products are brought into contact with acid rain, there is a risk in that glass in the colored layers is discolored in white or the like. Besides, there is also a risk in that the colored layers are peeled off. In addition, also when the colored layers are brought into contact with a detergent at the time of washing of the automotive window glass, there is a risk in that glass in the colored layers is discolored in white or the like. Besides, there is also a risk in that the colored layers are peeled off. Therefore, the glass powder is required to have acid resistance.

As glass powder satisfying such requirement, lead-based glass powder or bismuth-based glass powder has hitherto been used (see, for example, Patent Literature 1).

However, lead has a high environmental load. In addition, it cannot be said that a bismuth resource amount is sufficient, and bismuth is expensive.

Thus, in view of the above-mentioned problems, a technical object of the present invention is to provide a composite powder which can be fired at low temperature and has high acid resistance without introducing lead and bismuth.

### Solution to Problem

The inventors of the present invention have made various investigations. As a result, the inventors have found that the above-mentioned technical object can be achieved by strictly restricting the glass composition of glass powder. Thus, the finding is proposed as the present invention. That is, a composite powder according to one embodiment of the present invention comprises 55 mass % to 95 mass % of glass powder, 5 mass % to 45 mass % of inorganic pigment powder, and 0 mass % to 20 mass % of refractory filler powder, wherein the glass powder comprises as a glass composition, in terms of mol %, 45% to 62% of SiO₂, 0% to 10% of B₂O₃, 0% to 9% of Al₂O₃, 12% to 32% of ZnO, 12% to 28% of Li₂O+Na₂O+K₂O, 0% to 10% of BaO, and 0% to 15% of TiO₂+ZrO₂. Herein, the content of “Li₂O+Na₂O+K₂O” refers to the total content of Li₂O, Na₂O, and K₂O. The content of “TiO₂+ZrO₂” refers to the total content of TiO₂ and ZrO₂.

In the composite powder according to the embodiment of the present invention, the contents of SiO₂ and B₂O₃ in the glass powder are restricted to 45 mol % or more and 10 mol % or less, respectively. With this, acid resistance can be remarkably enhanced. Meanwhile, when the content of SiO₂ is increased and the content of B₂O₃ is reduced, a situation in which a softening point is increased and hence the firing temperature of the composite powder is increased is expected. However, as a result of extensive investigations, the inventors of the present invention have made a surprising finding that, when the content of alkali metal oxides is restricted to from 12 mol % to 28 mol %, the increase in softening point can be suppressed while the acid resistance is maintained without introducing lead and bismuth.

In the composite powder according to the embodiment of the present invention, it is preferred that the content of TiO₂+ZrO₂ in the glass powder be from 0.1% to 10%.

In the composite powder according to the embodiment of the present invention, it is preferred that the glass powder have a molar ratio SiO₂/B₂O₃ of from 5 to 15.

In the composite powder according to the embodiment of the present invention, it is preferred that the glass powder have a molar ratio ZnO/B₂O₃ of from 1 to 6.

In the composite powder according to the embodiment of the present invention, it is preferred that the content of BaO in the glass powder be from 0.1% to 5%.

In the composite powder according to the embodiment of the present invention, it is preferred that the content of SiO₂+ZnO in the glass powder be 65% or more. Herein, the content of “SiO₂+ZnO” refers to the total content of SiO₂ and ZnO.

In the composite powder according to the embodiment of the present invention, it is preferred that the content of Li₂O in the glass powder be from 5% to 20%.

In the composite powder according to the embodiment of the present invention, it is preferred that the glass powder be substantially free of PbO and Bi₂O₃. Herein, the “substantially free of” has a general meaning that the case where the explicit components are mixed at impurity levels is permitted, and specifically refers to the case where the contents of the explicit components are less than 0.1 mol %.

In the composite powder according to the embodiment of the present invention, it is preferred that the inorganic pigment powder comprise a Cr-based composite oxide. Herein, the “-based composite oxide” refers to a composite oxide containing the explicit component as an essential component.

In the composite powder according to the embodiment of the present invention, it is preferred that the composite powder comprise 55 mass % to 85 mass % of the glass powder, 15 mass % to 45 mass % of the inorganic pigment powder, and 0 mass % to 10 mass % of the refractory filler powder.

A composite powder paste according to one embodiment of the present invention comprises a composite powder and a vehicle, wherein the composite powder comprises the above-mentioned composite powder.

A glass sheet with a colored layer according to one embodiment of the present invention comprises a colored layer, wherein: the colored layer comprises a sintered compact of a composite powder; and the composite powder comprises the above-mentioned composite powder.

In the glass sheet with a colored layer according to the embodiment of the present invention, it is preferred that the glass sheet comprise a soda lime glass sheet.

### Advantageous Effects of Invention

According to the present invention, the composite powder which can be fired at low temperature and has high acid resistance without introducing lead and bismuth can be provided.

### DESCRIPTION OF EMBODIMENTS

A composite powder of the present invention comprises at least glass powder and inorganic pigment powder, and as required, refractory filler powder or the like. The glass powder is a component for allowing dispersion of the inorganic pigment powder and its fixing onto a soda lime glass sheet. The inorganic pigment powder is a component for allowing coloration in black or the like and thereby enhancing a shielding property against ultraviolet rays and visible light. The refractory filler powder is an optional component. The refractory filler powder is a component which increases mechanical strength, and is also a component for adjusting a thermal expansion coefficient. It should be noted that, in addition to the above-mentioned components, inorganic heat resistant whiskers or the like may be added in order to enhance mold releasability, and metal powder, such as Cu powder, may be added in order to enhance a color developing property.

In the composite powder of the present invention, the glass powder comprises as a glass composition, in terms of mol %, 45% to 62% of SiO₂, 0% to 10% of B₂O₃, 0% to 9% of Al₂O₃, 12% to 32% of ZnO, 12% to 28% of Li₂O+Na₂O+K₂O, 0% to 10% of BaO, and 0% to 15% of TiO₂+ZrO₂. The reasons why the contents of the components are restricted within the above-mentioned ranges are described below. It should be noted that, in the descriptions of the ranges of the contents of the components, the expression “%” represents “mol %”.

SiO₂ is a component which forms a glass skeleton, and is also a component which enhances acid resistance. The content of SiO₂ is from 45% to 62%, preferably from 46% to 59%, from 47% to 57%, or from 48% to 55%, particularly preferably from 49% to 53%. When the content of SiO₂ is too small, thermal stability (devitrification resistance) is liable to lower, and concurrently the acid resistance is liable to lower. In contrast, when the content of SiO₂ is too large, a softening point is increased, and hence the firing temperature of the composite powder is liable to be increased.

B₂O₃ is a component which forms the glass skeleton, and is also a component which reduces the softening point without increasing the thermal expansion coefficient. The content of B₂O₃ is from 0% to 10%, preferably from 1% to 8%, from 2% to 7%, or from 3% to 6.5%, particularly preferably from 4% to 6%. When the content of B₂O₃ is too large, the acid resistance is liable to lower. It should be noted that when the content of B₂O₃ is too small, the thermal stability is liable to lower.

The molar ratio SiO₂/B₂O₃ is preferably from 5 to 15, from 6 to 14, from 7 to 13, or from 8 to 12, particularly preferably from 9 to 11. When the molar ratio SiO₂/B₂O₃ is too small, the acid resistance is liable to lower. In contrast, when the molar ratio SiO₂/B₂O₃ is too large, the softening point is increased, and hence the firing temperature of the composite powder is liable to be increased.

Al₂O₃ is a component which enhances acid resistance. The content of Al₂O₃ is from 0% to 9%, preferably from 0% to 5%, from 0% to 3%, or from 0% to 2%, particularly preferably from 0% to less than 1%. When the content of Al₂O₃ is too large, the softening point is increased, and hence the firing temperature of the composite powder is liable to be increased.

ZnO is a component which reduces the softening point without increasing the thermal expansion coefficient. The content of ZnO is from 12% to 32%, preferably from 14% to 30%, from 16% to 28%, or from 18% to 26%, particularly preferably from 20% to 25%. When the content of ZnO is too small, the softening point is increased, and hence the firing temperature of the composite powder is liable to be increased. In addition, the thermal expansion coefficient is inappropriately increased, and it becomes difficult to match the thermal expansion coefficient with that of the soda lime glass sheet. In contrast, when the content of ZnO is too large, the acid resistance is liable to lower.

The content of SiO₂+ZnO is preferably 65% or more, 67% or more, 69% or more, or 70% or more, particularly preferably 71% or more. When the content of SiO₂+ZnO is too small, the thermal expansion coefficient is inappropriately increased, and it becomes difficult to match the thermal expansion coefficient with that of the soda lime glass sheet.

The molar ratio ZnO/B₂O₃ is preferably from 1 to 6, from 2 to 5.5, from 3 to 5, or from 3.3 to 4.8, particularly preferably from 3.5 to 4.5. With this, the softening point and the acid resistance are easily optimized without increasing the thermal expansion coefficient.

Li₂O+Na₂O+K₂O is a component which reduces the softening point. The content of Li₂O+Na₂O+K₂O is from 12% to 28%, preferably from 14% to 26%, from 16% to 24%, or from 17% to less than 23%, particularly preferably from 18% to 22%. When the content of Li₂O+Na₂O+K₂O is too small, the softening point is increased, and hence the firing temperature of the composite powder is liable to be increased. In contrast, when the content of Li₂O+Na₂O+K₂O is too large, water resistance and the acid resistance are liable to lower. In addition, the thermal expansion coefficient is inappropriately increased, and it becomes difficult to match the thermal expansion coefficient with that of the soda lime glass sheet.

Li₂O is a component which reduces the softening point without increasing the thermal expansion coefficient. The content of Li₂O is preferably from 0% to 25%, from 5% to 20%, from 7% to 18%, or from 8% to 16%, particularly preferably from 9% to 15%. When the content of Li₂O is too large, the water resistance and the acid resistance are liable to lower. In addition, there is a risk in that an unintended crystal is precipitated at the time of firing, resulting in abnormal expansion of a colored layer. It should be noted that, when the content of Li₂O is too small, the softening point is increased, and hence the firing temperature of the composite powder is liable to be increased.

Na₂O is a component which reduces the softening point. The content of Na₂O is preferably from 0% to 15%, from 0.1% to 12%, from 1% to 10%, or from 2% to 9%, particularly preferably from 3% to less than 8%. When the content of Na₂O is too large, the water resistance and the acid resistance are liable to lower. In addition, the thermal expansion coefficient is inappropriately increased, and it becomes difficult to match the thermal expansion coefficient with that of the soda lime glass sheet. It should be noted that, when the content of Na₂O is too small, the softening point is increased, and hence the firing temperature of the composite powder is liable to be increased.

K₂O is a component which reduces the softening point, but offers a small amount of reduction in softening point as compared to Li₂O and Na₂O. The content of K₂O is preferably from 0% to 8%, from 0% to 6%, from 0% to 5%, or from 0.1% to 4.5%, particularly preferably from 1% to 3%. When the content of K₂O is too large, the water resistance and the acid resistance are liable to lower. In addition, the thermal expansion coefficient is inappropriately increased, and it becomes difficult to match the thermal expansion coefficient with that of the soda lime glass sheet.

It is preferred that, among Li₂O, Na₂O, and K₂O, two kinds thereof be each introduced in the glass composition at a content of 0.1% or more. It is more preferred that the three kinds thereof be each introduced at a content of 0.1% or more. With this, an alkali mixing effect can be exhibited, and the thermal expansion coefficient and the softening point can be reduced while the acid resistance is maintained as compared to the case of introducing one kind thereof alone.

Among Li₂O, Na₂O, and K₂O, it is preferred to preferentially introduce Li₂O in order to optimize the thermal expansion coefficient and the softening point. The molar ratio Li₂O/(Li₂O+Na₂O+K₂O) is preferably 0.4 or more, or 0.5 or more, particularly preferably more than 0.5.

BaO is a component which enhances the thermal stability. The content of BaO is from 0% to 10%, preferably from 0% to 7%, from 0% to 5%, or from 0% to less than 3%, particularly preferably from 0.1% to less than 1%. When the content of BaO is too large, the thermal expansion coefficient is inappropriately increased, and it becomes difficult to match the thermal expansion coefficient with that of the soda lime glass sheet.

TiO₂+ZrO₂ is a component which enhances the acid resistance. The content of TiO₂+ZrO₂ is from 0% to 15%, preferably from 0.1% to 10%, from 1% to 8%, or from 1.5% to 7%, particularly preferably from 2% to 6%. When the content of TiO₂+ZrO₂ is too large, the thermal stability is liable to lower. In addition, the softening point is increased, and hence the firing temperature of the composite powder is liable to be increased. It should be noted that, when the content of TiO₂+ZrO₂ is too small, it becomes difficult to enhance the acid resistance.

TiO₂ is a component which enhances the acid resistance. The content of TiO₂ is preferably from 0% to 13%, from 0% to 10%, from 0.1% to 7%, or from 1% to 6%, particularly preferably from 1.5% to 5%. When the content of TiO₂ is too large, the thermal stability is liable to lower. In addition, the softening point is increased, and hence the firing temperature of the composite powder is liable to be increased. It should be noted that, when the content of TiO₂ is too small, the acid resistance is liable to lower.

ZrO₂ is a component which enhances the acid resistance. The content of ZrO₂ is preferably from 0% to 8%, from 0% to 5%, from 0% to 3%, or from 0% to 2%, particularly preferably from 0.1% to less than 1%. When the content of ZrO₂ is too large, the thermal stability is liable to lower. In addition, the softening point is increased, and hence the firing temperature of the composite powder is liable to be increased.

In addition to the above-mentioned components, another component may be introduced in an amount of, for example, up to 15%, as required. The introduction amount of the other component is preferably 10% or less, particularly preferably 5% or less. Examples of the component which may be introduced in addition to the above-mentioned components include the following components.

SrO is a component which enhances the thermal stability. The content of SrO is preferably from 0% to 10%, from 0% to 7%, from 0% to 5%, or from 0% to less than 3%, particularly preferably from 0% to less than 1%. When the content of SrO is too large, the thermal expansion coefficient is inappropriately increased, and it becomes difficult to match the thermal expansion coefficient with that of the soda lime glass sheet.

CuO is a component for allowing coloration in black. The content of CuO is preferably from 0% to 8%, from 0% to 5%, from 0% to 3%, or from 0.5% to 2%, particularly preferably from 0% to less than 1%. When the content of CuO is too large, the thermal stability is liable to lower.

In addition to the above-mentioned components, MgO, CaO, Cr₂O₃, MnO, SnO₂, CeO₂, P₂O₅, La₂O₃, Nd₂O₃, CO₂O₃, F, Cl, or the like may be introduced.

It should be noted that the glass powder is preferably substantially free of PbO and Bi₂O₃.

The composite powder of the present invention comprises 55 mass % to 95 mass % of the glass powder, 5 mass % to 45 mass % of the inorganic pigment powder, and 0 mass % to 20 mass % of the refractory filler powder.

The content of the glass powder is from 55 mass % to 95 mass %, preferably from 55 mass % to 90 mass %, from 55 mass % to 85 mass %, or from 60 mass % to 80 mass %, particularly preferably from 65 mass % to 75 mass %. When the content of the glass powder is too small, the fixability of the colored layer onto the soda lime glass sheet is liable to lower. In contrast, when the content of the glass powder is too large, the inorganic pigment powder is relatively reduced. As a result, a shielding property against ultraviolet rays lowers, and an organic adhesive is liable to be deteriorated. In addition, a shielding property against visible light lowers, and a design property is liable to lower.

The thermal expansion coefficient of the glass powder is preferably from 70×10⁻⁷/° C. to 110×10⁻⁷/° C., or from 75×10⁻⁷/° C. to 105×10⁻⁷/° C., particularly preferably from 80×10⁻⁷/° C. to 100×10⁻⁷/° C. When the thermal expansion coefficient is too low, it becomes difficult to match the thermal expansion coefficient with that of the soda lime glass sheet. Also when the thermal expansion coefficient is too high, it becomes difficult to match the thermal expansion coefficient with that of the soda lime glass sheet. It should be noted that, when the thermal expansion coefficient of the colored layer and the thermal expansion coefficient of the soda lime glass sheet are mismatched, cracks are liable to occur in the colored layer and/or the soda lime glass sheet, and even dropping of the colored layer or the like is liable to occur. Herein, the “thermal expansion coefficient of the glass powder” refers to a value measured with a push rod-type TMA apparatus in a temperature range of from 30° C. to 300° C. As a measurement sample, there may be used a sample obtained by densely sintering the glass powder, followed by processing into a predetermined shape or a sample obtained by forming molten glass into a bulk form and annealing the glass, followed by processing into a predetermined shape.

The glass transition point of the glass powder measured with a push rod-type TMA apparatus is preferably from 415° C. to 510° C., or from 435° C. to 490° C., particularly preferably from 455° C. to 480° C. When the glass transition point is too low, other characteristics, in particular, the acid resistance and the thermal stability are liable to lower. In contrast, when the glass transition point is too high, the firing temperature is increased, and thermal deformation of the soda lime glass sheet may be caused at the time of firing. It should be noted that a lower glass transition point enables a reduction in firing temperature. Herein, the “glass transition point of the glass powder measured with a push rod-type TMA apparatus” is measured in air at a temperature increase rate of 10° C./min. As a measurement sample, there may be used a sample obtained by densely sintering the glass powder, followed by processing into a predetermined shape or a sample obtained by forming molten glass into a bulk form and annealing the glass, followed by processing into a predetermined shape.

The glass transition point of the glass powder measured with a macro-type DTA apparatus is preferably from 400° C. to 500° C., or from 420° C. to 480° C., particularly preferably from 440° C. to 470° C. When the glass transition point is too low, other characteristics, in particular, the acid resistance and the thermal stability are liable to lower. In contrast, when the glass transition point is too high, the firing temperature is increased, and thermal deformation of the soda lime glass sheet may be caused at the time of firing. It should be noted that a lower glass transition point enables a reduction in firing temperature and the enhancement of the color developing property of the inorganic pigment powder. Herein, the “glass transition point of the glass powder measured with a macro-type DTA apparatus” is measured in air at a temperature increase rate of 10° C./min.

The deformation point of the glass powder measured with a push rod-type TMA apparatus is preferably from 450° C. to 550° C., or from 470° C. to 530° C., particularly preferably from 490° C. to 520° C. When the deformation point is too low, other characteristics, in particular, the acid resistance and the thermal stability are liable to lower. In contrast, when the deformation point is too high, the firing temperature is increased, and thermal deformation of the soda lime glass sheet may be caused at the time of firing. It should be noted that a lower deformation point enables a reduction in firing temperature. Herein, the “deformation point of the glass powder measured with a push rod-type TMA apparatus” is measured in air at a temperature increase rate of 10° C./min. As a measurement sample, there may be used a sample obtained by densely sintering the glass powder, followed by processing into a predetermined shape or a sample obtained by forming molten glass into a bulk form and annealing the glass, followed by processing into a predetermined shape.

The softening point of the glass powder measured with a macro-type DTA apparatus is preferably from 500° C. to 620° C., or from 510° C. to 590° C., particularly preferably from 530° C. to 570° C. When the softening point is too low, other characteristics, in particular, the acid resistance and the thermal stability are liable to lower. In contrast, when the softening point is too high, the firing temperature is increased, and thermal deformation of the soda lime glass sheet may be caused at the time of firing. It should be noted that a lower softening point enables a reduction in firing temperature. Herein, the “softening point of the glass powder measured with a macro-type DTA apparatus” refers to a temperature at the fourth inflection point obtained through measurement with a macro-type DTA apparatus. The measurement is performed in air at a temperature increase rate of 10° C./min.

The crystallization temperature of the glass powder measured with a macro-type DTA apparatus is preferably 550° C. or more, 580° C. or more, or from 590° C. to 700° C., particularly preferably from 600° C. to 650° C. When the crystallization temperature is too low, glass is liable to be devitrified at the time of melting and forming, and stable production of the glass powder becomes difficult. It should be noted that the thermal expansion coefficient of the colored layer can be reduced when a low expansion crystal is precipitated in the glass powder at the time of firing. Herein, the “crystallization temperature of the glass powder measured with a macro-type DTA apparatus” refers to a crystallization peak temperature obtained through measurement with a macro-type DTA apparatus. The measurement is performed in air at a temperature increase rate of 10° C./min.

The glass powder has an average particle diameter D₅₀ of preferably 10 μm or less, or from 1 μm to 7 μm, particularly preferably from 2 μm to 5 μm. The glass powder has a maximum particle diameter Dₘₐₓ of preferably 15 μm or less, particularly preferably from 3 μm to 10 μm. When the particle size of the glass powder is too large, screen printability is liable to lower. In addition, the color tone of the colored layer is liable to be non-uniform. Herein, the “average particle diameter D₅₀” refers to a value obtained through measurement with a laser diffractometer, and represents, in a cumulative particle size distribution curve on a volume basis obtained through measurement by laser diffractometry, a particle diameter at which the integration amount of particles from a smaller particle side is 50% in a cumulative manner. The “maximum particle diameter Dₘₐₓ” refers to a value obtained through measurement with a laser diffractometer, and represents, in a cumulative particle size distribution curve on a volume basis obtained through measurement by laser diffractometry, a particle diameter at which the integration amount of particles from a smaller particle side is 99% in a cumulative manner.

The content of the inorganic pigment powder is from 5 mass % to 45 mass %, preferably from 10 mass % to 45 mass %, from 15 mass % to 45 mass %, or from 20 mass % to 40 mass %, particularly preferably from 25 mass % to 35 mass %. When the content of the inorganic pigment powder is too small, the shielding property against ultraviolet rays lowers, and the organic adhesive is liable to be deteriorated. In addition, the shielding property against visible light lowers, and the design property is liable to lower. In contrast, when the content of the inorganic pigment powder is too large, the glass powder is relatively reduced, and the fixability of the colored layer onto the soda lime glass sheet is liable to lower.

The inorganic pigment powder is preferably a composite oxide. The composite oxide exhibits high heat resistance, high acid resistance, and high water resistance by virtue of its stable structure. One kind or two or more kinds selected from the following composite oxides are preferred as such composite oxide: an Al—Co-based composite oxide, an Al—Co—Cr-based composite oxide, an Al—Cr—Fe—Zn-based composite oxide, an Al—Co—Li—Ti-based composite oxide, an Al—Cu—Fe—Mn-based composite oxide, an Al—Fe—Mn-based composite oxide, an Al—Si-based composite oxide, a Ba—Ni—Ti-based composite oxide, a Ca—Cr—Si—Sn-based composite oxide, a Co—Cr-based composite oxide, a Co—Cr—Fe—Mn-based composite oxide, a Co—Cr—Fe—Ni-based composite oxide, a Co—Cr—Fe—Ni—Si—Zr-based composite oxide, a Co—Cr—Fe-based composite oxide, a Co—Cr—Fe—Mn-based composite oxide, a Co—Cr—Fe—Ni—Zn-based composite oxide, a Co—Fe-based composite oxide, a Co—Fe—Mn—Ni-based composite oxide, a Co—Li—P-based composite oxide, a Co—Ni—Si—Zr-based composite oxide, a Co—Ni—Nb—Ti-based composite oxide, a Co—Ni—Sb—Ti-based composite oxide, a Co—Ni—Ti—Zn-based composite oxide, a Co—Si-based composite oxide, a Co—Si—Zn-based composite oxide, a Co—Ti-based composite oxide, a Cr—Cu-based composite oxide, a Cr—Cu—Mn-based composite oxide, a Cr—Fe-based composite oxide, a Cr—Fe—Mn-based composite oxide, a Cr—Fe—Zn-based composite oxide, a Cr—Nb—Ti-based composite oxide, a Cr—Sb—Ti-based composite oxide, an Fe—Cr-based composite oxide, an Fe—Mn-based composite oxide, an Fe—Ti-based composite oxide, an Fe—Ti—W-based composite oxide, an Fe—Ti—Zn-based composite oxide, an Fe—Zn-based composite oxide, a Ni—Nb—Ti-based composite oxide, a Ni—Sb—Ti-based composite oxide, a Ni—Ti—W-based composite oxide, and an Sb—Sn-based composite oxide. Examples of the inorganic pigments may comprise (Co,Fe,Mn)(Fe,Cr,Mn)₂O₄, (Ni,Co,Fe)(Fe,Cr)₂O₄, (Ni,Co,Fe)(Fe,Cr)₂O₄.(Zn,Fe)(Fe,Cr)₂O₄, (Co,Fe,Mn)(Fe,Cr,Mn)₂O₄, (Fe,Mn)(Fe,Mn)₂O₄ (manganese ferrite black spinel), (Fe,Mn)(Fe,Cr,Mn)O₄, Cu(Cr,Mn)₂O₄, CuCr₂O₄, (Co,Fe)(Fe,Cr)₂O₄, (Co,Ni)O.ZrSiO₄, (Sn,Sb)O₂, (Ni,Co,Fe)(Fe,Cr)₂O₄.ZrSiO₄, Fe(Fe,Cr)₂O₄, (Zn,Fe)(Fe,Cr)₂O₄, (Zn,Fe)(Fe,Cr,Al)₂O₄, (Fe,Co)Fe₂O₄, (Zn,Fe)Fe₂O₄, (Ti,Sb,Ni)O₂, (Ti,Sb,Cr)O₂, (Ti,Cr,Nb)O₂, (Ti,Sb,Ni,Co)O₂, (Ti,Nb,Ni,Co)O₂, (Ti,Ni,W)O₂, (Ti,Ni,Nb)O₂, (Ti,Fe,W)O₂, (Ti,Nb,Ni)O₂, (Zn,Fe)(Fe,Cr)₂O₄, (Fe,Zn)Fe₂O₄:TiO₂, (Co,Ni,Zn)TiO₄, CoCr₂O₄, CoAl₂O₄, CoAl₂O₄:TiO₂:Li₂O, CoSi₂O₄, Co₂TiO₄, CoLiPO₄, Co(Al,Cr)₂O₄, Fe₂TiO₄, Cr₂O₃:Fe₂O₃, (Co,Zn)₂SiO₄, 2NiO, 3BaO, 17TiO₂, and CaO, SnO₂, SiO₂:Cr₂O₃.

The inorganic pigment powder is preferably black, and the following powder is preferred as the black inorganic pigment powder: an Al—Cu—Fe—Mn-based composite oxide, an Al—Fe—Mn-based composite oxide, a Co—Cr—Fe-based composite oxide, a Co—Cr—Fe—Mn-based composite oxide, a Co—Cr—Fe—Ni-based composite oxide, a Co—Cr—Fe—Mn-based composite oxide, a Co—Cr—Fe—Ni—Zn-based composite oxide, a Co—Fe—Mn—Ni-based composite oxide, a Cr—Cu-based composite oxide, a Cr—Cu—Mn-based composite oxide, a Cr—Fe—Mn-based composite oxide, an Fe—Mn-based composite oxide, TiₙO₂ₙ₋₁ (n represents an integer), Cr₂O₃, or C. Examples thereof may comprise (Co,Fe,Mn)(Fe,Cr,Mn)₂O₄, (Ni,Co,Fe)(Fe,Cr)₂O₄, (Ni,Co,Fe)(Fe,Cr)₂O₄.(Zn,Fe)(Fe,Cr)₂O₄, (Co,Fe,Mn)(Fe,Cr,Mn)₂O₄, (Fe,Mn)(Fe,Mn)₂O₄, (Fe,Mn)(Fe,Cr,Mn)O₄, Cu(Cr,Mn)₂O₄, CuCr₂O₄, (Co,Fe)(Fe,Cr)₂O₄, and carbon black.

As the inorganic pigment powder, a Cr-based composite oxide, such as a Cr—Cu—Mn-based composite oxide, a Cr—Fe—Mn-based composite oxide, a Cr—Co-based composite oxide, or a Cr—Fe—Ni-based composite oxide, is preferred from the viewpoints of the shielding property against visible light, the shielding property against ultraviolet rays, and the color developing property in black. A Cr—Cu—Mn-based composite oxide and a Cr—Fe—Mn-based composite oxide are particularly preferred.

The inorganic pigment powder has an average particle diameter D₅₀ of preferably 9 μm or less, particularly preferably from 1 μm to 4 μm. The inorganic pigment powder has a maximum particle diameter Dₘₐₓ of preferably 5 μm or less, particularly preferably from 2 μm to 6 μm. When the particle size of the inorganic pigment powder is too large, the screen printability is liable to lower. In addition, the color tone of the colored layer is liable to be white.

The content of the refractory filler powder is from 0 mass % to 20 mass %, preferably from 0 mass % to 15 mass %, from 0 mass % to 10 mass %, from 0 mass % to 5 mass %, or from 0 mass % to 1 mass %, particularly preferably from 0 mass % to less than 0.1 mass %. When the content of the refractory filler powder is too large, the fixability of the colored layer onto the soda lime glass sheet is liable to lower.

The following substance may be used as the refractory filler powder: cordierite, willemite, alumina, zirconium phosphate, zircon, zirconia, tin oxide, mullite, silica, β-eucryptite, β-spodumene, a β-quartz solid liquid, zirconium phosphate tungstate, or the like.

The composite powder has a thermal expansion coefficient of preferably from 70×10⁻⁷/° C. to 110×10⁻⁷/° C., or from 75×10⁻⁷/° C. to 95×10⁻⁷/° C., particularly preferably from 80×10⁻⁷/° C. to 92×10⁻⁷/° C. When the thermal expansion coefficient is too low, it becomes difficult to match the thermal expansion coefficient with that of the soda lime glass sheet. Also when the thermal expansion coefficient is too high, it becomes difficult to match the thermal expansion coefficient with that of the soda lime glass sheet.

A composite powder paste of the present invention comprises a composite powder and a vehicle, wherein the composite powder comprises the above-mentioned composite powder. The composite powder paste of the present invention encompasses the technical feature of the composite powder of the present invention. The content of the technical feature has already been described, and hence its description is omitted for convenience.

The vehicle is formed mainly of a solvent and a resin. The solvent is added for the purpose of uniformly dispersing the composite powder while dissolving the resin. The resin is added for the purpose of adjusting the viscosity of the paste. In addition, a surfactant, a thickener, or the like may be added as required.

The following resins may be used as the resin: an acrylic acid ester (acrylic resin), ethylcellulose, a polyethylene glycol derivative, nitrocellulose, polymethylstyrene, polyethylene carbonate, a methacrylic acid ester, and the like. In particular, an acrylic acid ester or ethylcellulose is preferred from the viewpoint of its satisfactory heat decomposability.

The following solvents may be used as the solvent: pine oil, N,N′-dimethylformamide (DMF), α-terpineol, a higher alcohol, γ-butyrolactone (γ-BL), tetralin, butylcarbitol acetate, ethyl acetate, isoamyl acetate, diethylene glycol monoethyl ether, diethylene glycol monoethyl ether acetate, benzyl alcohol, toluene, 3-methoxy-3-methylbutanol, triethylene glycol monomethyl ether, triethylene glycol dimethyl ether, dipropylene glycol monomethyl ether, dipropylene glycol monobutyl ether, tripropylene glycol monomethyl ether, tripropylene glycol monobutyl ether, propylene carbonate, N-methyl-2-pyrrolidone, and the like. In particular, α-terpineol is preferred from the viewpoints of its high viscosity and satisfactory solubility of a resin or the like therein.

The composite powder paste is produced by, for example, mixing the composite powder and the vehicle, and then uniformly kneading the mixture with a three roll mill.

The composite material paste is applied onto a soda lime glass sheet with an applicator, such as a screen printer, and then subjected to a drying step and a firing step. With this, a colored layer can be formed on the surface of the soda lime glass sheet. In an application for an automotive window glass, the portion onto which the composite material paste is applied is a peripheral edge portion of a windshield glass, a side window glass, or a rear window glass. In the application for an automotive window glass, a silver paste layer is formed so as to cover part of the composite powder paste after the application of the composite powder paste in some cases. The drying step is a step of volatilizing the solvent. The conditions of the drying step are generally as follows: at from 70° C. to 150° C. for from 10 minutes to 60 minutes. The firing step is a step of sintering the composite powder while decomposing and volatilizing the resin, to fix the colored layer onto the surface of the soda lime glass sheet. The conditions of the firing step are generally as follows: at from 580° C. to 640° C. for from 5 minutes to 30 minutes. As the firing temperature in the firing step is lower, production efficiency is enhanced more.

A glass sheet with a colored layer of the present invention comprises a colored layer, wherein: the colored layer comprises a sintered compact of a composite powder; and the composite powder comprises the above-mentioned composite powder. The glass sheet with a colored layer of the present invention encompasses the technical feature of the composite powder of the present invention. The content of the technical feature has already been described, and hence its description is omitted for convenience.

A crystal may be precipitated in the colored layer as long as the fixability onto the soda lime glass sheet and the color developing property are not impaired.

The glass sheet with a colored layer of the present invention may be formed into not only a flat sheet shape but also a shape obtained through bending processing or the like. In an application for an automotive window glass, the glass sheet with a colored layer is subjected to bending processing with a forming apparatus, such as a press machine or a vacuum suction forming apparatus. In the bending processing, stainless steel coated with glass fiber fabric is generally used for a forming mold.

### Examples

Now, the present invention is described by way of Examples. It should be noted that the following Examples are merely illustrative. The present invention is by no means limited to the following Examples.

Examples (Sample Nos. 1 to 9) and Comparative Example (Sample No. 10) of the present invention are shown in Table 1.

TABLE 1

| | | No. 1 | No. 2 | No. 3 | No. 4 | No. 5 |
|---|---|---|---|---|---|---|
| Glass | SiO₂ | 50.0 | 53.0 | 52.0 | 52.5 | 50.0 |
| composition | B₂O₃ | 5.0 | 5.0 | 5.0 | 5.0 | 5.5 |
| (mol %) | Li₂O | 10.0 | 10.0 | 14.0 | 12.0 | 16.0 |
| | Na₂O | 7.5 | 7.5 | 3.5 | 5.5 | 3.5 |
| | K₂O | 4.1 | 4.0 | 1.0 | 1.5 | 0.0 |
| | BaO | 0.7 | 0.7 | 0.5 | 0.4 | 0.0 |
| | ZnO | 17.2 | 18.3 | 21.5 | 18.6 | 21.0 |
| | TiO₂ | 5.0 | 1.0 | 2.5 | 4.0 | 4.0 |
| | ZrO₂ | 0.5 | 0.5 | 0.0 | 0.5 | 0.0 |
| Li + Na + K | | 21.6 | 21.5 | 18.5 | 19.0 | 19.5 |
| Ti + Zr | | 5.5 | 1.5 | 2.5 | 4.5 | 4.0 |
| Si/B | | 10.00 | 10.60 | 10.40 | 10.50 | 9.09 |
| Zn/B | | 3.44 | 3.66 | 4.30 | 3.72 | 3.82 |
| Si + Zn | | 67.2 | 71.3 | 73.5 | 71.1 | 71.0 |
| Density (g/cm³) | | 2.92 | 2.89 | 2.95 | 2.94 | 2.95 |
| Thermal expansion | | 105 | 106 | 88 | 90 | 87 |
| coefficient of glass | | | | | | |
| alone (×10⁻⁷/° C.) | | | | | | |
| Glass | TMA | 462 | 457 | 468 | 470 | 466 |
| transition | DTA | 445 | 441 | 457 | 462 | 457 |
| point (° C.) | | | | | | |
| Deformation point (° C.) | | 507 | 498 | 512 | 516 | 505 |
| Softening point (° C.) | | 557 | 559 | 573 | 575 | 557 |
| Crystallization | | >650 | >650 | 610 | 633 | 608 |
| temperature (° C.) | | | | | | |
| Inorganic pigment | | Cr—Cu—Mn | Cr—Cu—Mn | Cr—Cu—Mn | Cr—Cu—Mn | Cr—Cu—Mn |
| powder (mass %) | | 35 | 35 | 40 | 35 | 35 |
| Thermal expansion | | 108 | Not | 90 | 94 | 90 |
| coefficient of | | | measured | | | |
| sintered compact of | | | | | | |
| composite powder | | | | | | |
| (×10⁻⁷/° C.) | | | | | | |
| Acid resistance | | ∘ | ∘ | ∘ | ∘ | ∘ |
| | | No. 6 | No. 7 | No. 8 | No. 9 | No. 10 |
| Glass | SiO₂ | 52.0 | 51.0 | 52.0 | 54.0 | 57.3 |
| composition | B₂O₃ | 6.5 | 5.0 | 5.5 | 5.5 | 16.4 |
| (mol %) | Li₂O | 14.0 | 14.0 | 15.0 | 14.0 | 7.2 |
| | Na₂O | 3.5 | 3.5 | 3.5 | 3.5 | 3.1 |
| | K₂O | 0.0 | 0.0 | 0.0 | 0.0 | 0.0 |
| | BaO | 0.0 | 0.0 | 0.0 | 0.0 | 0.0 |
| | ZnO | 21.5 | 24.0 | 22.5 | 22.5 | 14.8 |
| | TiO₂ | 2.5 | 2.5 | 1.0 | 2.5 | 0.8 |
| | ZrO₂ | 0.0 | 0.0 | 0.5 | 0.0 | 0.5 |
| Li + Na + K | | 17.5 | 17.5 | 18.5 | 17.5 | 10.3 |
| Ti + Zr | | 2.5 | 2.5 | 1.5 | 2.5 | 1.3 |
| Si/B | | 8.00 | 10.20 | 9.45 | 9.82 | 3.49 |
| Zn/B | | 3.31 | 4.80 | 4.09 | 4.09 | 0.90 |
| Si + Zn | | 73.5 | 75.0 | 74.5 | 76.5 | 72.1 |
| Density (g/cm³) | | 2.93 | 2.96 | 2.95 | 2.85 | Not |
| | | | | | | measured |
| Thermal expansion | | 80 | 81 | 89 | 81 | Not |
| coefficient of glass | | | | | | measured |
| alone (×10⁻⁷/° C.) | | | | | | |
| Glass | TMA | 469 | 470 | 472 | 474 | Not |
| transition | | | | | | measured |
| point (° C.) | DTA | 461 | 458 | 465 | 461 | Not |
| | | | | | | measured |

| | | | | | |
|---|---|---|---|---|---|
| Deformation point (° C.) | 513 | 511 | 519 | 520 | Not |
| | | | | | measured |
| Softening point (° C.) | 570 | 563 | 570 | 565 | 636 |
| Crystallization | 617 | 610 | 612 | 615 | >650 |
| temperature (° C.) | | | | | |
| Inorganic pigment | Cr—Cu—Mn | Cr—Cu—Mn | Cr—Cu—Mn | Cr—Cu—Mn | Cr—Cu—Mn |
| powder (mass %) | 35 | 35 | 35 | 35 | 30 |
| Thermal expansion | 85 | 85 | Not | 84 | 75 |
| coefficient of | | | measured | | |
| sintered compact of | | | | | |
| composite powder | | | | | |
| (×10⁻⁷/° C.) | | | | | |
| Acid resistance | ∘ | ∘ | ∘ | ∘ | x |

First, raw materials were blended so as to achieve a glass composition shown in Table 1, and uniformly mixed to yield a glass batch. Then, the glass batch was placed in a platinum crucible, and melted at 1,300° C. for 2 hours. After that, the molten glass was formed into a film shape or a bulk shape. Next, the resultant glass film was pulverized with a ball mill, followed by air classification, to yield glass powder having an average particle diameter D₅₀ of 2.5 μm and a maximum particle diameter Dₘₐₓ of 6.0 μm. Each sample was measured for the density, the glass transition point, the deformation point, the softening point, and the crystallization temperature.

The density is a value measured by an Archimedes method. Glass in a bulk form subjected to annealing was used as a measurement sample.

The thermal expansion coefficient is a value measured with a push rod-type TMA apparatus in a temperature range of from 30° C. to 300° C. A sample obtained by processing the glass in a bulk form subjected to annealing into a predetermined shape was used as a measurement sample.

The glass transition point was measured with a push rod-type TMA apparatus and a macro-type DTA apparatus. The measurement was performed in air at a temperature increase rate of 10° C./min.

The deformation point (self-weight deformation temperature) is a value measured with a push rod-type TMA apparatus. A sample obtained by processing the glass in a bulk form subjected to annealing into a predetermined shape was used as a measurement sample.

The softening point is a temperature at the fourth inflection point obtained through measurement of each glass powder with a macro-type DTA apparatus. The measurement was performed in air at a temperature increase rate of 10° C./min.

The crystallization temperature is a peak temperature obtained through measurement of each glass powder with a macro-type DTA apparatus. The measurement was performed in air at a temperature increase rate of 10° C./min.

Next, the glass powder and inorganic pigment powder were mixed at a ratio shown in Table 1 (100 mass % in total), to yield a composite powder. Each composite powder was measured for the thermal expansion coefficient. It should be noted that, in Table 1, the “Cr—Cu—Mn” represents a Cr—Cu—Mn-based composite oxide (average particle diameter D₅₀: 1.5 μm, maximum particle diameter Dₘₐₓ: 4.0 μm) and the “Cr—Fe—Mn” represents a Cr—Fe—Mn-based composite oxide (average particle diameter D₅₀: 1.5 μm, maximum particle diameter Dₘₐₓ: 4.0 μm).

The thermal expansion coefficient of the composite powder is a value obtained through measurement of a measurement sample with a push rod-type TMA apparatus in a temperature range of from 30° C. to 300° C., the measurement sample being obtained by retaining and firing each composite powder at 580° C. for 20 minutes to densely sinter the composite powder, followed by processing into a predetermined shape.

Further, the resultant composite powder and a vehicle were mixed, and then uniformly kneaded with a three roll mill, to yield a composite powder paste. It should be noted that a vehicle obtained by dissolving ethylcellulose in α-terpineol was used as the vehicle, and the mass ratio of composite powder/vehicle was adjusted to from 2 to 3.

Next, the composite powder paste was screen printed on the entirety of one surface of a 10 cm square soda lime glass sheet (manufactured by Nippon Sheet Glass Co. Ltd., sheet thickness: 2.8 mm), and then dried at 120° C. for 20 minutes, loaded in an electric furnace at 580° C. and fired for 10 minutes, and naturally cooled to room temperature. Thus, a glass sheet with a colored layer having a thickness of 10 μm was obtained.

The acid resistance was evaluated as described below. The glass substrate with a colored layer was immersed in 0.1 N sulfuric acid (0.05 mol/l) at 80° C. for 8 hours. Then, the case where the colored layer did not drop, discoloration was not observed in observation from a soda lime glass sheet side, and a change in L* value before and after the immersion was +2 or less was evaluated as “∘”, and the case where the colored layer dropped or the case where the colored layer did not drop and discoloration was not observed in the observation from the soda lime glass sheet side, but a change in L* value before and after the immersion exceeded +2 was evaluated as “x”. It should be noted that the L* value was measured with CR-200 manufactured by Minolta Camera Co., Ltd.

As is apparent from Table 1, Sample Nos. 1 to 9 each exhibited good acid resistance. In contrast, Sample No. 10 exhibited poor acid resistance.

1. A composite powder, comprising 55 mass % to 95 mass % of glass powder, 5 mass % to 45 mass % of inorganic pigment powder, and 0 mass % to 20 mass % of refractory filler powder,
wherein the glass powder comprises as a glass composition, in terms of mol %, 45% to 62% of SiO₂, 0% to 10% of B₂O₃, 0% to 9% of Al₂O₃, 12% to 32% of ZnO, 12% to 28% of Li₂O+Na₂O+K₂O, 0% to 10% of BaO, and 0% to 15% of TiO₂+ZrO₂.

2. The composite powder according to claim 1, wherein a content of TiO₂+ZrO₂ in the glass powder is from 0.1% to 10%.

3. The composite powder according to claim 1, wherein the glass powder has a molar ratio SiO₂/B₂O₃ of from 5 to 15.

4. The composite powder according to claim 1, wherein the glass powder has a molar ratio ZnO/B₂O₃ of from 1 to 6.

5. The composite powder according to claim 1, wherein a content of BaO in the glass powder is from 0.1% to 5%.

6. The composite powder according to claim 1, wherein a content of SiO₂+ZnO in the glass powder is 65% or more.

7. The composite powder according to claim 1, wherein a content of Li₂O in the glass powder is from 5% to 20%.

8. The composite powder according to claim 1, wherein the glass powder is substantially free of PbO and Bi₂O₃.

9. The composite powder according to claim 1, wherein the inorganic pigment powder comprises a Cr-based composite oxide.

10. The composite powder according to claim 1, comprising 55 mass % to 85 mass % of the glass powder, 15 mass % to 45 mass % of the inorganic pigment powder, and 0 mass % to 10 mass % of the refractory filler powder.

11. A composite powder paste, comprising a composite powder and a vehicle,
wherein the composite powder comprises the composite powder of claim 1.

12. A glass sheet with a colored layer, comprising a colored layer, wherein:
the colored layer comprises a sintered compact of a composite powder; and
the composite powder comprises the composite powder of claim 1.

13. The glass sheet with a colored layer according to claim 12, wherein the glass sheet comprises a soda lime glass sheet.
